(19) United States
(12) Patent Application Publication
(10) Pub. No.: US 2021/0200940 A1
(43) Pub. Date: Jul. 1, 2021

(54) STREAMLINED JOB INTRODUCTION

(71) Applicant: Bus Stop Mamas LLC, Roseville, MN (US)

(72) Inventor: Mary Kay Ziniewicz, Roseville, MN (US)

(21) Appl. No.: 17/139,582

(22) Filed: Dec. 31, 2020

Related U.S. Application Data
(60) Provisional application No. 62/956,080, filed on Dec. 31, 2019.

(51) Int. Cl. G06F 40/174; H04L 12/58; G06F 3/0482

(52) U.S. Cl. CPC G06F 40/174; G06F 3/0482; H04L 51/00

(57) ABSTRACT

A method for facilitating job introductions between candidates and employers for one or more job listings in an online system is disclosed. The method includes accessing, by the system, a completed form containing candidate contact information associated with a selected job listing. The method further includes determining employer contact information based on the selected job listing and transmitting an electronic communication introducing the candidate and employer.

### BACKGROUND

Recent advancements in information technology have largely re-defined the way workforce development has progressed. Online tools provide employers the option to require vast amounts of information from job candidates. However, current online tools can be overly cumbersome and impersonal, requiring considerable effort that is time consuming and expensive. Moreover, current online tools can be subject to bias, predictive matching that eliminates candidates and restricts access to available jobs.

### SUMMARY

According to an aspect of the disclosure, a method for facilitating job introductions between candidates and employer customers for one or more job listings in an online system is disclosed. The method includes accessing, by a candidate device, a form containing candidate contact information associated with a selected job listing. The method further includes determining employer customer contact information based on the selected job listing and transmitting an electronic communication introducing the candidate and employer customer.

### BRIEF DESCRIPTION OF THE DRAWINGS

For a more complete understanding of the present invention, reference is made to the following detailed description and accompanying drawings. In the drawing, like reference characters refer to like parts throughout the views in which:

FIG. 1 illustrates a block diagram of a method for facilitating job introductions.

FIG. 2 illustrates a block diagram of a job introduction system; and

FIG. 3 is a block diagram of a user interface for a job introduction system.

### DETAILED DESCRIPTION

Described herein is a digital workforce system that introduces businesses to off market talent, for example stay at home parents. Businesses easily post full time, part time and temporary jobs on the website system, the key is flexibility. Using the system, a hybrid workforce model can deliver social and economic upswing with one-click. The quick-acting, super affordable, innovative technology is a win-win-win for the ecosystem of suppliers: business, candidates and community.

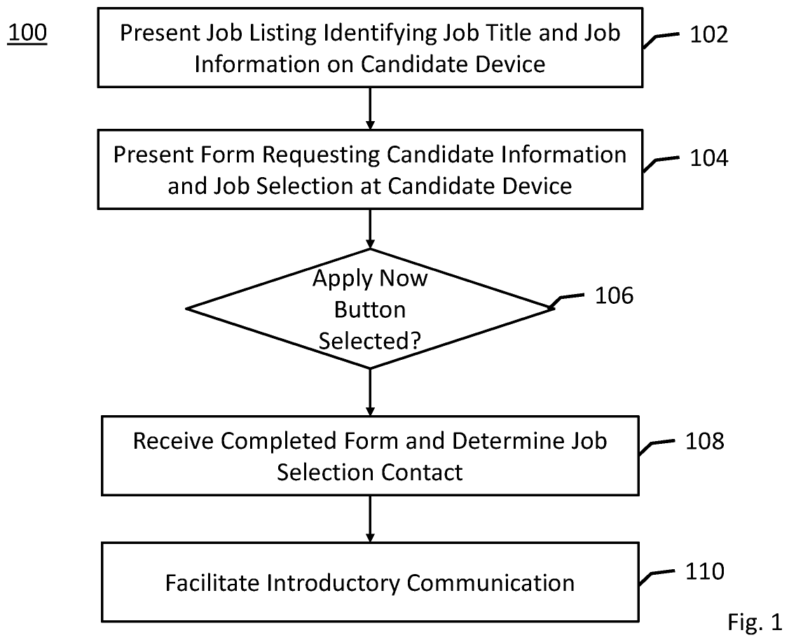

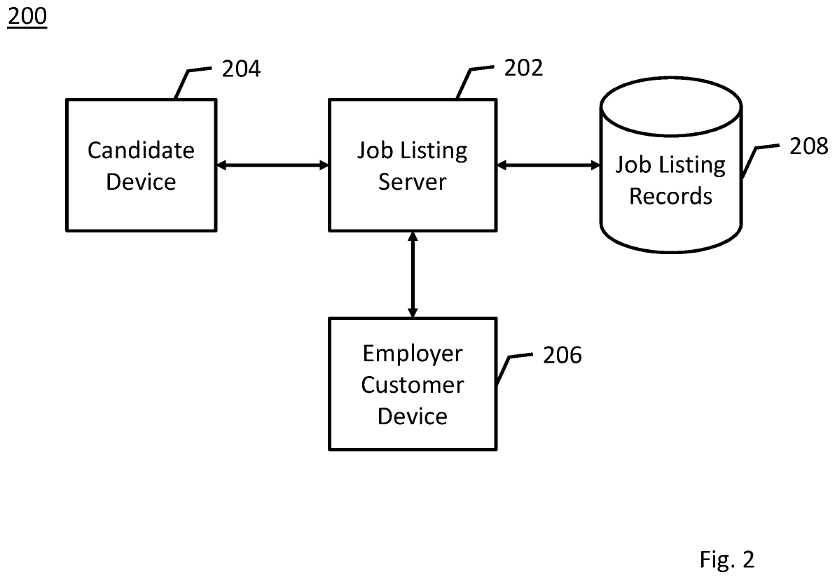

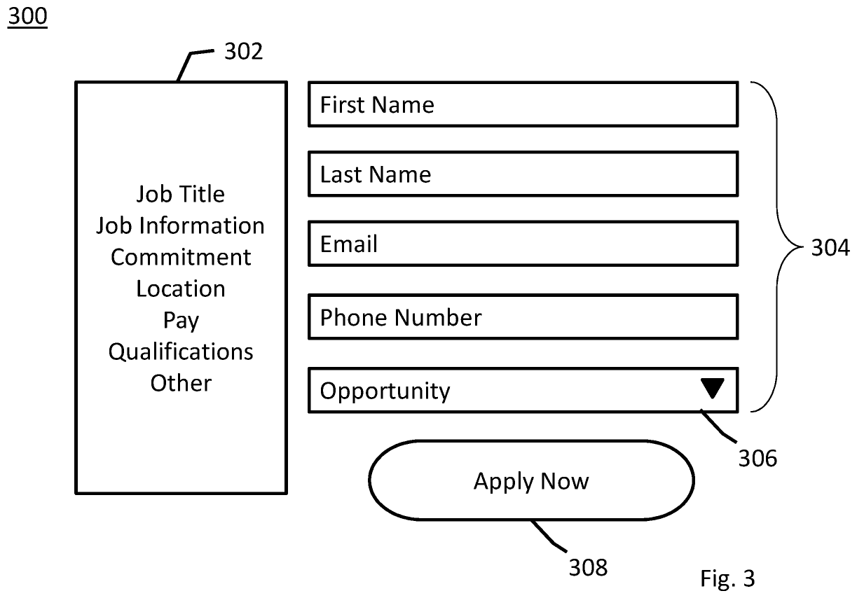

FIG. 1 is a flow diagram of a method 100 for facilitating a job introduction using a job introduction system 200, shown in FIG. 2, which illustratively includes a job listing server 202, a candidate device 204, an employer customer device 206 and a job listing record database 208. With further reference to FIG. 3, a user interface 300 can be used to present information on the candidate device 204 in accordance with method 100 and system 200. The method 100 includes a step 102 in which a job listing 302 including job title and job information is presented on the candidate device 204. The candidate may access the user interface 300 via a user device, such as, a mobile phone, a personal computer, etc. In one embodiment, the user interface 300 is a web browser and the device 204 is configured to display the user interface 300 based on code stored on the job listing server 202. Job listing information can be provided to the job listing server 202 using the employer customer device 206 and a corresponding input mechanism (e.g., a form). The job listing server 202 collects the job listing information from the employer customer device 206 and stores the information in the job listing record database 208. In one embodiment, to operate, the job listing server 202 includes only the job listing record database 208, a web document to interface with the candidate device 204 and an email server to facilitate communication between the candidate device 204 and the employer customer device 206.

Method 100 continues to step 104, wherein a form 304 is presented to the candidate on the candidate device 204. The form 304 is part of the user interface 300 and requests contact information from the candidate, including first name, last name, email address and phone number. In one embodiment, the form 304 does not request further information from the candidate, such as job history, address, interests, qualifications, credentials, resume, etc. To this end, the method 100 can be streamlined and create an efficient and inviting approach to performing job introductions. The form 304 does include an opportunity selection component 306, which allows a candidate to select a job listing from the job listing record database 208 for which the candidate would like to apply. In one embodiment, the opportunity selection component 306 is a drop-down menu, only listing those jobs that are available to the candidate. It is worth noting that job information 302 and form 304 are available for access to all candidates regardless of past job history, credentials or other factors that may be restrictive to candidates. For example, a candidate may have 20 years of experience, but based on life circumstances, may choose to select a job for which the candidate is overly qualified. Method 100 and system 200, due to the absence of utilizing criteria to eliminate candidates, is useful in making introductions for jobs that cannot readily be matched to candidates based on job history or other factors.

The candidate device 204 can include a communication module that directly communicates with a corresponding communication module of the job listing server 202. In a similar manner, the employer customer device 206 can include a communication module that directly communicates with the communication module of the job listing server 202. The job listing server 202 can also include an email server that operates to send electronic messages to a mailbox associated with both the candidate and the employer.

Once the candidate inputs information into the form 304 and selects an opportunity using opportunity selection component 306, the candidate can press an activation button 308 (e.g., with a single click) on user interface 300, which is illustratively denoted with the phrase “Apply Now”. Based on the completed form and the selection component 306, a customer contact for the selected job listing can be determined at step 108. For example, the contact can include an email address associated with the employer that posted the opportunity that was selected. Using the candidate email address entered on the form 304 and the employer email address associated with the employer customer, method 100 proceeds to step 110, wherein an introductory communication is facilitated. The introductory communication can automatically be generated by the job listing server 202, where a communication can be sent from the job listing server 202 to both the candidate and employer customer. After the communication is sent, the candidate and employer have each other's contact information such that, if desired, further information can be exchanged and the candidate can be hired by the employer.

Based on the method 100 and system 200 described above, a streamlined, fair and efficient approach to facilitating job introductions is realized. The introduction can be facilitated with a simple, single activation button 308. As a result, candidates can easily select various job opportunities without sharing private information and with a lower burden to completion. In one embodiment, only selected information (e.g., less than 10 informational elements, less than 5 information elements) is requested from a candidate. In a further embodiment, only first name, last name and contact information is requested from the candidate. In yet a further embodiment, the introductory communication is automatically generated in response to the candidate activating button 308. In a further embodiment, the job listing server 202 can utilize cookies that will save candidate information for form 304 and automatically populate the form 304 with the candidate information upon the device 204 accessing job listing server 202.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A method for facilitating job introductions between candidates and employers for one or more job listings in an online system, comprising:
presenting, by the system, a user interface including a form containing candidate contact information associated with a selected job listing a on a candidate device;
receiving from the candidate device by a job listing server the form and a single click indication of interest in the selected job listing;
determining employer customer contact information based on the selected job listing; and
transmitting an electronic communication from the job listing server that selectively provides contact information for the candidate and the employer customer.

2. The method of claim 1, wherein the candidate contact information does not include prior job history for the candidate.

3. The method of claim 1, wherein the form further includes a drop down menu listing available job listings.

4. The method of claim 1, wherein the candidate contact information consists of first name, last name and email address.

5. The method of claim 1, wherein the candidate contact information consists of first name, last name and phone number.

6. The method of claim 1, wherein the candidate contact information consists of first name, last name, phone number and email address.

7. The method of claim 1, wherein transmitting the electronic communication is performed without transmitting job history information about candidates.

8. A job introduction system, comprising:
a job listing server having a communication module;
a candidate device configured to present a user interface with a form to enter candidate contact information and a job selection;
an activation button positioned in the user interface proximate the form, wherein upon operation of the activation button, the communication module transmits an electronic communication to both an employer address associated with the job selection and a candidate address associated with the entered candidate contact information.

9. The job introduction system of claim 8, wherein the job listing server is further associated with a plurality of job listing records.

10. The job introduction system of claim 8, wherein the job listing server does not receive job history information about candidates.
